(19) United States
(12) Patent Application Publication
(10) Pub. No.: US 2007/0038438 A1
(43) Pub. Date: Feb. 15, 2007

(54) Context knowledge modeling method for sharing and reusing context knowledge in context-aware system

(76) Inventors: Joon Myun Cho, Seo-Gu (KR); Hyun Kim, Yuseong-Gu (KR); Hyoung Sun Kim, Seo-Gu (KR); Joo Haeng Lee, Seo-Gu (KR); Chung Seong Hong, Seo-Gu (KR); Jin Mi Jung, Okchen-Gun (KR)

Correspondence Address: LADAS & PARRY LLP, 224 SOUTH MICHIGAN AVENUE, SUITE 1600, CHICAGO, IL, 60604, US

(21) Appl. No.: 11/438,855

(22) Filed: May 23, 2006

(30) Foreign Application Priority Data
Aug. 11, 2005 (KR) 2005-106548

(51) Int. Cl. G06F 17/27

(52) U.S. Cl. 704/9

(57) ABSTRACT

A context knowledge modeling method is provided. The context knowledge modeling method includes the steps of: a) defining a context knowledge space as a two-dimensional space based on an abstract level and an application domain of knowledge; b) locating a share ontology as a highest level of the abstract level for defining a common ontology concept at a plurality of applications and services performed in various environment and domains; c) locating at least one of domain ontologies as a lower abstract level than the share ontology by taking over the ontology concept defined at the share ontology and defining a class and an attribute specialized at a corresponding domain and a developing application; and d) locating one or more instance bases expressing knowledge about real objects to have a lower abstract level than the domain ontologies.

### BACKGROUND OF THE INVENTION

1. Field of the Invention

The present invention relates to a context knowledge modeling method for sharing and reusing a context knowledge in a context-aware system, and more particularly, to a context knowledge modeling method for effectively and conveniently sharing and reusing context knowledge with ubiquitous objects and a context-aware system.

2. Description of the Related Art

In a ubiquitous computing environment, ubiquitous objects interact with one another to understand a user's request without user's awareness and proper services are provided to a user according to the request at anywhere and anytime. The ubiquitous objects may be a sensor device, a service device and a software agent. Such a ubiquitous computing environment requires a context aware system to support the ubiquitous objects to dynamically adapt variations of context.

The context denotes knowledge about states of objects and related environments such as a user, a device, a software agent, peripheral environments thereof and locations. For example, the context may be a room temperature, a noise level and an intensity of a light. The context knowledge may also include information about activities, rolls and intensions related to the devices, the software and the software agents.

A major function of the context aware system is to manage a context model expressing the context knowledge and to provide a proper context knowledge according to the context model. The context model must support the ubiquitous object to predict, reuse and share a context knowledge, effectively.

In a conventional technology, context models are generally classified into a formal model and an informal model by a method of expressing the knowledge. The informal context model is generally created based on a proprietary knowledge expressing scheme. Context Toolkit, Cooltown and Henricksen study group are widely known for the informal context model. The Context Toolkit expresses a context knowledge using property values and tuple. The cooltown expresses the context by assigning web details to each of objects based on a web based model. Or, the Henricksen study group expresses a context knowledge using ER and UML, and it was introduced in an article entitled “Modeling context information in pervasive computing system,” Proceedings of the first international conference on Pervasive computing, volume 2414 of Lecture Notes in computer science, 2002. However, it is difficulty to use the informal context model to estimate context knowledge.

On the contrary, the formal context model supports a predetermined level of context knowledge estimation because the forma context model uses a formal knowledge expressing method to express the context knowledge. Ranganathan study group uses a linear expression of terminologies expressed as DAML+OIL. Wang's study group, Chen's study group and Kim HakRae's study group create a context model based on an ontology web language (OWL) and such a study was introduced in an article entitled “An ontology for context-aware pervasive computing environments” the knowledge engineering review, 18(3), 2003. Especially, theses study groups introduce using of the clearly expressed ontology knowledge.

However, these conventional study groups did not teach how to share and how to reuse the context knowledge in detail, comparatively. Differently from other study groups using the OWL, Wang emphasizes the reuse of an upper ontology by classifying the ontology into the upper ontology and the domain ontology However, Wang fails to teach how the ontology is classified into the upper and the domain ontology, what kind of reference is used and how the ontology is stratified.

Furthermore, studies about how to create a context knowledge model for sharing the context knowledge were insufficient. Kim ByungMan's study group introduced a method of classifying context knowledge models into an environmental model and a user model where the environmental model expresses environmental information obtained from sensors and the user model expresses preferences and activity information of a user which are obtained through interacting with a user through an application interface. In the classification of the environmental model and the user model, the difference of methods of obtaining knowledge and the difference of using the knowledge are reflected. Therefore, it is useful for developers of knowledge base (ontology and instance) to analyze and to conceptualize target knowledge. However, Kim's study does not teach in detail which knowledge is included in a user model or in an environmental model or how the classified knowledge is structured.

Meanwhile, an information modeling method and a database searching system was introduced in Korea Patent Publication No. 2000-23961(May 6, 2000). The conventional method improves a function of searching a database for normalized data. However, the conventional method does not teach a method of modeling to effective use, share and reuse the informal context knowledge.

As described above, effective sharing and reusing the context knowledge may not be achieved through generating the context model using the formal knowledge expressing scheme and using the generated context models in the context based applications. In order to effectively share the context knowledge, context models must be uniformly created based on a constant scheme considering how to identify context knowledge components such as, a class, a property and an instance in a context model and how to systemize the identified context knowledge components.

### SUMMARY OF THE INVENTION

Accordingly, the present invention is directed to a context knowledge modeling method for sharing and reusing context knowledge in a context-aware system, which substantially obviates one or more problems due to limitations and disadvantages of the related art.

In order to create a context based application, it is very important to provide an infrastructure for managing a context model that expresses a context knowledge and providing a proper context knowledge according to the context model. The context model must be created with a context knowledge estimating function to effectively support sharing and reusing of the context knowledge.

It is an object of the present invention to provide a method of modeling a context knowledge to support various context based applications to easily share and reuse the context knowledge without errors.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a context knowledge modeling method including the steps of: a) defining a context knowledge space as a two-dimensional space based on an abstract level and an application domain of knowledge; b) locating a share ontology as a highest level of the abstract level for defining a common ontology concept at a plurality of applications and services performed in various environment and domains; c) locating at least one of domain ontologies as a lower abstract level than the share ontology by taking over the ontology concept defined at the share ontology and defining a class and an attribute specialized at a corresponding domain and a developing application; and d) locating one or more instance bases expressing knowledge about real objects to have a lower abstract level than the domain ontologies.

There is another aspect of the present invention to provide a context knowledge modeling method including the steps of: a) defining a category class as a highest level class where the category class is permanent and not capable of providing an identification condition and transferring; b) defining a type class as a lower level class than other type class or the category class where the type class is permanent and provides an identification condition; c) defining a phased sortal class as a lower class of the type class where the phase sortal class is impermanent, undependable and is not capable or providing an new global identification condition; and d) defining a material role class as a lower class of the type class or the phase sortal class where the material role class is impermanent and dependable any conditions.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a context aware system according an embodiment of the present invention;

FIG. 2 is a block diagram of the context knowledge manager module 2 shown FIG. 1 for describing operations thereof;

FIG. 3 shows modularization and hierarchical structuring a context knowledge of a context knowledge modeling method according to the present invention;

FIG. 4 shows a meta concept for identifying and structuring context knowledge components in a context knowledge modeling method according to the present invention; and

FIG. 5 is a block diagram illustrating a context model created using a context based modeling method according to the present invention.

### DETAILED DESCRIPTION OF THE INVENTION

Reference will now be made in detail to the preferred embodiments of the present invention, examples of which are illustrated in the accompanying drawings.

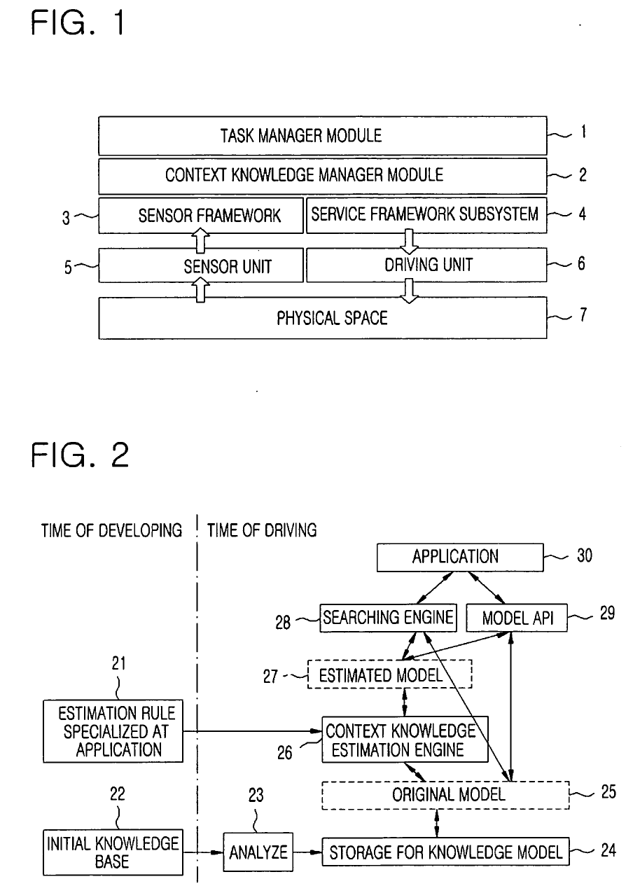

FIG. 1 is a block diagram illustrating a context aware system according an embodiment of the present invention.

Referring to FIG. 1, the context aware system according to the present invention includes a task manager module 1, a context knowledge manager module 2, a sensor framework 3 and a service framework subsystem 4.

For example, the context aware system according to the present invention may be used for a residence environment such as apartments and offices. In this case, the context aware system according to the present embodiment includes high performance central server installed in the residence environment and the high performance central server includes core modules of the context aware system such as the task manager module 1 and the context knowledge manager module 2 with program modules requiring high computing power for voice and video recognition. The home or the office includes a sensor unit 5, a sensor framework 3 for managing the sensor unit 5 and a driving unit 6 configured of various home network devices and a service framework subsystem 4 for managing the driving unit 6. The central server is shared by various ubiquitous environments such as homes and offices. Each of the ubiquitous environments includes sub-environments. For example, the ubiquitous environment such as the home includes sub environments such as a bedroom, a living room and a kitchen.

The sensor unit 5 detects context data in a physical space 7 and the sensor framework 3 processes the detected context data. Then, the sensor framework 3 transmits the processed context data to the context knowledge manager module 2 in the central server. The task manager module 1 uses the collected context knowledge in the context based application to dynamically provide a proper service.

As described above, a general design concept of a context aware system is to manage and to decouple service devices such as the context based application, the sensor unit 5 and the driving unit 6 based on the context knowledge. Therefore, context aware system must support various environments and a context information managing layer in a lower software structure must be separated from other layers to be effectively and dynamically adapted into varying environments.

The task manager module 1 drives, manages and controls the context based applications. The context based application is configured of various task rules, theoretically. Each of the task rules is an expression of an event-condition-action (ECA) that describes contexts and requests from a user or an application through an event and a condition. Also, the task rule describes a service to perform as an action when a corresponding context is created. In case of the ECA task rule is performed, necessary context knowledge is referenced through a context knowledge manager module 2.

The sensor framework 3 maps the sensor unit 4 of the physical space 7 to a virtual space, and supports the context based application to dynamically provide services by extracting context data from the sensed information transmitted from the sensor unit 4 and transmitting the extracted context data to the context knowledge manger module 2. The sensed information from the sensor unit 5 may include voice information, video information, temperature/humidity information and user schedule information. The sensor framework 3 also processes the extracted context data such as interpretation as well as the extraction. For example, processes of filing and merging the sensed information may be performed.

The context knowledge manager module 2 estimates tacit knowledge based on the context information transmitted from the sensor framework 3, and stores and manages the estimated knowledge. The context knowledge managed by the context knowledge manager module 2 is referenced when the context based application is performed. Therefore, the context knowledge manager module 2 controls the sensor framework 3 to add new information into context models and to modify the context models and provides functions for searching context knowledge and estimating tacit knowledge in order to express the context knowledge with the context model.

The service framework subsystem 4 manages interfaces for controlling various driving units 6 in the physical space 7 such as a lighting device, a display and an electric appliance. The service framework subsystem 4 also manage interfaces for computer program modules providing services used by the context based applications such as processing voice and schedule and codes thereof.

FIG. 2 is a block diagram of the context knowledge manager module 2 shown FIG. 1 for describing operations thereof.

FIG. 2, operations of the context knowledge manager module 2 are classified into operations performed during developing and operations performed while driving.

At first, an initial knowledge base 22 is produced as an initial context model and an estimation rule 21 is generated according to an application using various tools for producing context knowledge while developing.

While driving, a context model of the initial knowledge base 22 is loaded into a knowledge model storage 24 which is managed by the context knowledge manager module 2 shown in FIG. 1. Such a loaded context model is specified as an original model 25 and provided externally through an identical conceptual view of a resource description framework (RDF). Then, the context knowledge manager module 2 generates a model 27 estimated using a context knowledge estimating engine 26. Although the estimated model 27 is also provided as the RDF model view, the estimated model includes tacit knowledge which is not clearly expressed in the context model. When the context knowledge estimation engine 26 is applied, the estimation rule 21 specified to an application is also applied with the estimation rule of the context knowledge engine 26. Then, the context based applications 30 uses necessary knowledge through the searching engine 28, and generates and modifies knowledge from context models using a model application programming interface (API) 30 which provides a function of accessing a context model.

Hereinafter, the method of modeling context knowledge according to the present invention will be clearly described using a meeting helping application and a temperature controlling application as an example.

The meeting helping application is an application helping proceeding of a meeting by recognizing a location of a user. Accordingly, the meeting helping application is generally executed in an office environment having a RFID sensor, a voice sensor (Microphone) and a beam projector. The temperature controlling application is an application that drives an air conditioner or provides a related service by analyzing information about a user prefer temperature when a user enters in a predetermined space.

If a worker enters an office, a RFID sensor detects information about the worker and the location and transmits the detected information to a context knowledge manager module of a context aware system. That is, if a worker having a RFID tag enters a predetermined space with a RFID sensor installed, the RFID sensor transmits a serial number of a corresponding tag and ID information to the sensor framework layer of the context aware system shown in FIG. 1. The context knowledge manger module compares information about meeting arranged at a current time in an office and information about a worker's location, analyzes the worker entering the office as a participant of the meeting based on the comparison result, reflects the analyzing result into the context model and executes a corresponding meeting helping application.

Since the context based application performed in the context aware system is provided based on each environment, a plurality of context based applications may be performed in single environment. For example, the temperature controlling application and the meeting helping application may be executed in the same office at the seam time. In this case, it a peripheral environment is changed by the context based application, for example, the temperature of the office is down by the temperature controlling application, the changed environment of the office influences the other application. It is because a plurality of applications share single environment. Therefore, singe context model must be shared by a plurality of context based applications. Meanwhile, a same context based application may be driven in multiple environments. For example, the temperature controlling application and the meeting helping application may be driven in an office B. Therefore, the context model developed for the context based application of the office A must be reusable.

Various programmers and organizations may cooperate to adapt the context aware system in the real environment with their own purposes. That is, the context based application is not developed by one program or one organization only. Independent organizations and programmers cooperates one another to build the context aware system with different purposes. Therefore, the context knowledge must be effectively sharable and reusable.

The context knowledge modeling method according to the present invention is proposed to satisfy such requirements. That is, the context knowledge modeling method according to the present invention provides a solution how to divide the context knowledge into modules and layers and which reference is used for effective sharing and reusing. Also, the context knowledge modeling method according to the present invention provides how to identify context knowledge components such as class, property and instance and how to build a system for the context knowledge components. Accordingly, the context knowledge modeling method according to the present invention creates a context model constantly and systemically. Therefore, the context knowledge modeling method according to the present invention allows the context based application to easily determine how to find target context knowledge in a context model and how to reflect changed context information into the context model without any errors. Furthermore, the context knowledge modeling method according to the present invention allows the context aware system to easily and effectively manage and maintain the context model.

The context knowledge modeling method according to the present invention includes the steps of modularizing the context knowledge and hierarchically structuring the modularized context knowledge; and identifying a context knowledge component properly to each modularized context model and organizing the context knowledge components. In the context knowledge modularizing and structuring step, the knowledge is classified into a knowledge frequently shared and reused and a knowledge not shared and reused, and the modularized context knowledge is hierarchically structured. In the context knowledge component identifying and organizing step, meta concept is defined even to identify similar context knowledge components, and formal and clear rules for applying are assigned to each meta concept.

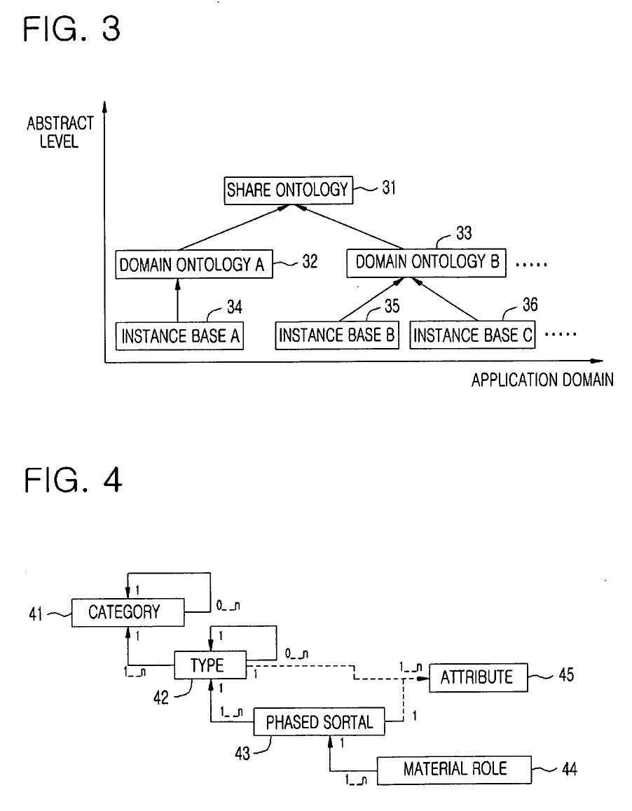

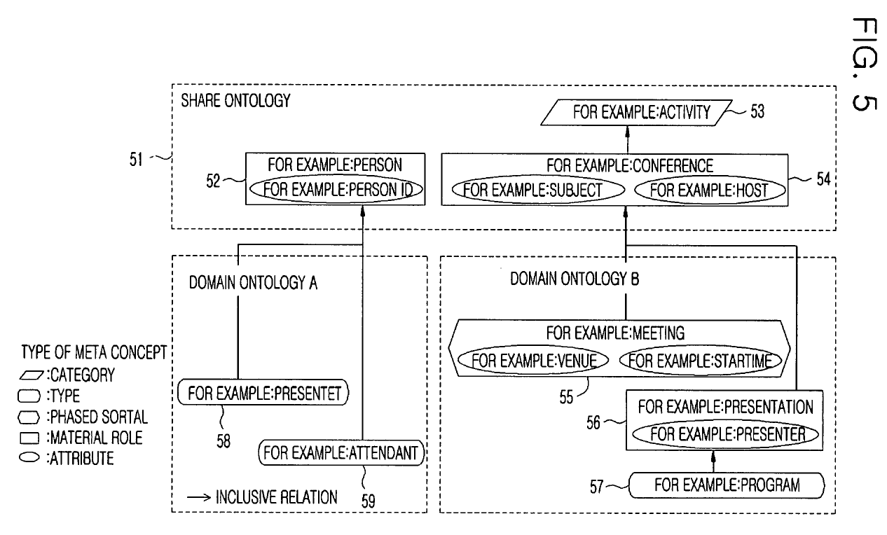

Hereinafter, the context knowledge modularizing and hierarchically structuring step and the content knowledge component identifying and organizing step in the context knowledge modeling method according to the present invention will be described with reference to FIGS. 3 and 4.

Referring to FIG. 3, a context knowledge space is simplified as a two-dimensional plan configured of two reference axes, one denoting an abstract level 31 and other denoting an application domain 32.

The abstract level 31 is a vertical axis of two-dimensional space shown in FIG. 3. The vertical axis is used as modularizing and hierarchically structuring. Generally, knowledge having a higher abstract level has a higher probability to be shared or reused by various applications. For example, knowledge about a physical space, a user or a device is commonly used by various application programs. It is because such knowledge is as a higher knowledge than others, configures a back born of a context model and used as an index.

In the context knowledge modeling method according to the present invention, the vertical axis is classified into a share ontology 31, at least one of domain ontologies 32 and 33 which are a lower hierarchy of the share ontology 31, and at least one of instance bases 34, 35 and 36 which configure a lower hierarchy of the domain ontology.

The share ontology 31 is distributed when a context aware system is built. The share ontology 31 defines various common ontology concepts such as a class and a property shared by various applications or services performed in various environments or domains. The context based application and the service provides the highest ontology knowledge and guides the domain ontologies 32 and 33 to define aggregation level and granularity ontology concepts.

The domain ontologies 32 and 33 are distributed when the context based application and the service are developed. The domain ontologies 32 and 33 define further detailed classes and properties to be specified to the corresponding domain and the developed application by receiving the higher class and the higher property from the share ontology 31. The reason of defining the further detailed classes and properties is that the knowledge defined in the share ontology 31 is insufficient to express the context knowledge required to an application performed in a predetermined domain. The domain ontologies 32 and 33 provides knowledge thereof to the context based application and the service, and plays a role as a schema of a relation between real objects for the instance bases 34, 35 and 36.

As shown, the instance bases 34, 35 and 36 are lowest hierarchies at the vertical axis. The instance bases 34, 35 and 36 express knowledge of real objects. The instance is generated and continuously modified while the context based application is driven. Also, the instance bases 34, 35 and 36 provide context information of a physical space to the context based application and the service.

A horizontal axis of the context knowledge space denotes an application domain performed in the context based application. It is because that the context based applications and the services are grouped based on an applying domain such as environments in home, office or car. Also, if the environment is modified by performing one or more applications or services, it influences other applications or services performed in the same environment and the common context knowledge must be shared. That is, the context model must be modularized based on classification of such application environments.

FIG. 4 shows a meta concept for identifying and structuring context knowledge components in a context knowledge modeling method according to the present invention.

In FIG. 4, a numeral reference marked near to both ends of an arrow denotes a multiplicity of a relation between modeled concepts. That is, the numeral reference denotes that a plurality of domains may be provided as many as the numeral reference in single domain concept modeled using a meta concept connected to the opposite end of the arrow with the numeral reference. A solid line with an arrow denotes an inheritance relation between a higher concept and a lower concept. That is, the attribute of the higher concept inherits to the lower concept.

The context knowledge modeling method introduces a meta concept for modeling a context knowledge by applying Guarino's higher ontology theory and a logical applying theory.

The Guarino's higher ontology theory classifies objects of a physical space into ontological distinctions such as a category, a type, a phased sortal and a material role using an ontological nature such as identify, rigidity and dependence. Also, clear characteristics and constraints are assigned into the classified ontological distinctions.

In the present invention, the category class 41 is defined as the highest hierarchy The category class 41 does not provide and transfer an identification condition although it remains permanently. Therefore, the category class 41 cannot have a clearly-limited membership condition. The category class 41 plays a role dividing the context knowledge of a target domain into predetermined sectors.

The type class 42 may be defined the highest class or defined a lower class of the category class 41. The type class remains permanently and provides global identifying conditions. When the type class 42 finely describes other type classes, the type class 42 receives the global identification condition from the higher class and provides own identification conditions, additionally.

The condition for identifying such as a global identification condition and a local identification condition is defined as an attribute 54 of a corresponding class and becomes necessary and sufficient membership condition. The identification condition, that is, an attribute used as the necessary and sufficient membership condition of a class, is one of attributes in the class, which is not permanent and dependant. It is because that the classification condition must be essential at least for the corresponding class in order to independently identify instances regardless of the time and the context. Also, the identification condition must be dependable to the corresponding class. If the instance is not dependable and can have any value as a corresponding attribute, it is not helpful to independently identify the instance. Attributes of class that is not included in an identification condition is defined as an attribute that is not necessary and not sufficient.

The phased sortal class 43 is defined as a lower class of the type class 42. It is because the phased sortal class 43 takes over the global identification condition from the type class 42. The phased sortal class 43 is impermanent and undependable, and provides a local identification condition although new global identification condition is not provided. That is, the phased sortal class 43 has an identification condition varied according to the time and the context. For example, a caterpillar and a butterfly are identical object with other forms. In this case, the location identification condition thereof may be varied according to the time and the context.

The material role class 44 is defined as a lower class of the type class 42 or a lower class of the phased sortal class 43. The material role class 44 is impermanent and dependable to any context. The material role class 44 is a role performed by a corresponding object in a predetermined event representing a relation of general objects. The material roll class 44 takes over an identification condition of the real object performing the corresponding role.

The instance base generates and manages instances of the type class 42 and the phased sortal class 43 only. According to the meta concept of the present invention, the category class 41 and the material role class 44 cannot have instance directly. It is because that the category class 41 cannot have clear membership condition and objects included in the material role class 44 are equal to the instances of the type class 43 or the phased sortal class 43. When the objects are generated in the instance base, attributes defined as the membership condition must be created together. Meanwhile, attributes not defined as the membership condition may be created when the context based application program or the service.

Hereinafter, context models created according to a context based modeling method according to the present invention will be described with reference to FIG. 5.

FIG. 5 is a block diagram illustrating a context model created using a context based modeling method according to the present invention.

Classes and attributes having higher abstract level are defined in a share ontology 51. Such classes and attributes are commonly used by various context based application and domains such as a person 52, an activity 53 and a conference 54. Classes and attributes having lower abstract level are defined in domain ontologies A and B. Such lower abstract level classes and attribute are specified at a predetermined application such as the meeting helping application, and may include a meeting 55, a presentation 56, a program 57, a presenter 58 and an attendant 59.

The context knowledge components such as classes and attributes of the context model are identified and structured according to the meta concept. For example, the person class 52 is modeled as the type class because the person class 52 is permanent and provides an identification condition independently identified as an instance. The PersonID is modeled as an identification condition of the person class 52. Therefore, the PersonID is defined as an attributed of the person class 52 and expressed as an necessary and sufficient membership condition. Meanwhile, the attendant class 59 is modeled as the material role class since it is not permanent, is dependable to a predetermined instance of a meeting class 55 and does not provide new identification condition. Also, the attendant class 59 is modeled as a lower class of the person class 52.

Attributes related to the attendant class 59 (material role class) such as AttendingMeeting is defined in the person class 52 as well as the PersonID that is an identification condition. Since the AttendingMeeting attribute is not an identification condition, the AttendingMeeting attribute is not defined as a membership condition differently from the PersonID attribute.

Instances of the type class such as Person and the phased sortal class such as Meeting are expressed in the instance base. It is because that classes of the material role class such as Attendant cannot generate instance directly. When instance of person class is connected to instances of the Meeting class through the AttendingMeeting relation which are binary relation between attributes, the attendant class becomes indirect instance. Therefore, the AttendingMeeting relation is dynamically generated and deleted according to variation of the context. On the contrary, attributes used as a membership condition such as the identification condition PersonID are generated when the object is generated and have an identical value until the corresponding object is deleted.

As described above, it becomes easy to share, maintain and manage context knowledge if the ontological meaning of context knowledge components such as classes and attributes becomes clear. For example, when knowledge components of a person object are required to be created, it becomes clear that instances of the Person class are only required to be created without creating the attendant class. If the person object is expressed as the instance of the attendant class because it is not clear which class the instances are created in, it is very difficult to find where the knowledge component expressing the person object is in the context model without additional and temporal (ad-hoc) knowledge.

It is also essential to produce a user definition estimation rule as well as the context model for the context based application. For example, when a location (location attribute) of a person object becomes identical to a location of a meeting object (Venue attribute value), the person object is connected to the meeting object through the AttendingMeeting relation.

If the ontological meaning of the context knowledge such as classes and attribute become clear, dynamically varied and modified relations are limited to attributes corresponding to non identification conditions such as classes of the material role class and related AttendingMeeting attribute. Since the context knowledge related to the participant or the presenter of the meeting is uniformly expressed through instances of the person class, it requires only the AttendingMeeting relation of the person object to be changed.

If the context knowledge related to the person is not uniformly expressed through the person object and is expressed through various classes expressing the presenter and the participants, it requires instances of all corresponding classes to be created and user definition estimation rules to be created to modify all of related attributes of generated objects. In this case, there may be a greater possibility to generate inconsistency between context knowledge due to the omission of the knowledge to be modified.

As described above, the context knowledge modeling method according to the present invention proposes well-prepared references to modularize and to hierarchically organize context knowledge for the context aware system. Therefore, the present invention allows the various context-based applications to easily share and reuse the context knowledge. Furthermore, the context knowledge modeling method creates the context model using meta concepts clearly assigned with application concepts. The context knowledge components can be clearly identified even if they are similar one another and can be organized as a similar structure. Therefore, the context knowledge modeling method according to the present invention allows the context based application to determine where the necessary context knowledge is and how the modified context information is reflected without generating any errors.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A context knowledge modeling method comprising the steps of:
a) defining a context knowledge space as a two-dimensional space based on an abstract level and an application domain of knowledge;
b) locating a share ontology as a highest level of the abstract level for defining a common ontology concept at a plurality of applications and services performed in various environment and domains;
c) locating at least one of domain ontologies as a lower abstract level than the share ontology by taking over the ontology concept defined at the share ontology and defining a class and an attribute specialized at a corresponding domain and a developing application; and
d) locating one or more instance bases expressing knowledge about real objects to have a lower abstract level than the domain ontologies.

2. The context knowledge modeling method of claim 1, wherein the ontology concept of the step b) is a class and an attribute, and the share ontology provides a highest level ontology knowledge to a context based application and service and guides the domain ontologies to define ontology concepts similar to an integrated level.

3. The context knowledge modeling method of claim 1, wherein the domain ontology of the step c) provides a domain ontology knowledge to a context based application and service and performs a role of a schema for a relation between a real object and objects in the instance bases.

4. The context knowledge modeling method of claim 1, wherein the instance bases in the step d) provide context information of a physical space to a context based application and service.

5. A context knowledge modeling method comprising the steps of:
a) defining a category class as a highest level class where the category class is permanent and not capable of providing an identification condition and transferring;
b) defining a type class as a lower level class than other type class or the category class where the type class is permanent and provides an identification condition;
c) defining a phased sortal class as a lower class of the type class where the phase sortal class is impermanent, undependable and is not capable or providing an new global identification condition; and
d) defining a material role class as a lower class of the type class or the phase sortal class where the material role class is impermanent and dependable any conditions.
